(19) United States
(12) Patent Application Publication
(10) Pub. No.: US 2025/0301964 A1
(43) Pub. Date: Oct. 2, 2025

(54) SUPPORT ASSEMBLY AND PLANTING DEVICE

(71) Applicant: Vego Innovations, Inc., Tomball, TX (US)

(72) Inventors: Guangyuan XIONG, Tomball, TX (US); Zhulin LIU, Shenzhen (CN)

(73) Assignee: Vego Innovations, Inc., Tomball, TX (US)

(21) Appl. No.: 18/800,149

(22) Filed: Aug. 12, 2024

(30) Foreign Application Priority Data
Mar. 26, 2024 (CN) 202420598624.7

(51) Int. Cl. A01G 9/02

(52) U.S. Cl. CPC A01G 9/028

(57) ABSTRACT

A support assembly and a planting device are provided. The support assembly includes a platform and a support frame. The platform is configured for bearing planting medium. The support frame is arranged below the platform for supporting the platform. The support frame includes a first support plate and a second support plate. The first support plate and the second support plate are detachably connected together and intercrossed with each other, for firmly support of the platform. It is easy to assemble and disassemble the support assembly. After being disassembled, the support assembly has a small volume to facilitate transportation.

### FIELD OF THE INVENTION

The present invention relates to the field of planting technology, and more particularly to a support assembly and a planting device.

### DESCRIPTION OF THE RELATED ART

A planting device includes a planting bed, a garden bed, a planter, etc., It is a device or structure that is configured to provide a growing environment for plants, to accommodate soil or other planting medium, and to provide support and growing space for plants. The plant bed can be arranged indoors or outdoors, in order to plant a variety of plants, including vegetables, flowers, herbs, etc.

In order to save the amount of filled soil, it is necessary to install a supporting frame in the planting device to upraise the filling position. But existing support frames have complicated structures which result in difficulty in assembly/disassembly, a large volume and high transportation cost.

### SUMMARY OF THE INVENTION

In view of this, the application provides a support assembly and a planting device.

In one aspect, the application provides a support assembly for a planting device. The support assembly comprises:
a platform, for bearing planting medium;
a support frame, settled below the platform, for supporting the platform;
wherein the support frame comprises a first support plate and a second support plate, the first support plate and the second support plate are detachably connected together and intercrossed with each other, for firmly support of the platform.

In some embodiments, the first support plate defines at least one first slot, and the second support plate defines at least one second slot, the at least one first slot corresponds to the at least one second slot in position so that the first support plate and the second support plate are able to be intercrossed to achieve a detachable connection therebetween. For example, the at least one first slot is aligned with the at least one second slot in a first direction. The at least one second slot is located on the extension line of the at least one first slot.

In some embodiments, the first support plate defines a first slot extending in a first direction, with one end of the first slot penetrating one side of the first support plate in the first direction, and a first limiting part is defined on the first support plate, between another end of the first slot and another side of the first support plate in the first direction; the second support plate defines a second slot extending in the first direction, with one end of the second slot penetrating one side of the second support plate in the first direction, and a second limiting part is defined on the second support plate, between another end of the second slot and another side of the second support plate in the first direction; wherein the first limit part is inserted into the second slot and the second limiting part is inserted into the first slot, so that the first support plate and the second support plate are intercrossed, to achieve a detachable connection therebetween.

In some embodiments, the first support plate along the first direction has a first side and a second side opposing to the first side, the first support plate defines multiple first slots apart from each other, and at least one of the multiple first slots has its one end penetrating the first side, and at least one of the multiple first slots has its one end penetrating the second side.

In some embodiments, the second support plate along the first direction has a third side and a fourth side opposing to the third side, the second support plate defines multiple second slots apart from each other, and all of the multiple second slots penetrates the second support plate toward a same direction.

In some embodiments, the support frame comprises multiple first support plates and multiple second support plates, an amount of the first slots in each of the multiple first support plates is as same as an amount of the multiple second support plates, and an amount of the second slots in each of the multiple second support plates is as same as an amount of the multiple first support plates; and the multiple first support plates are arranged along a second direction and spaced from each other, the multiple second support plates are arranged along a third direction and spaced from each other, the multiple first support plates and the multiple second support plates are intercrossed with each other and form a grid structure, and the first direction, the second direction and the third direction are perpendicular to each other.

In some embodiments, the support frame comprises three first support plates and four second support plates. Each of the first support plates defines four first slots spaced apart from each other. Among the four first slots of each of the first support plates, two of the four first slots located at opposite out sides penetrate the first side of the first support plate, and another two of the four first slots located at middle penetrate the second side of the first support plate. Each of the second support plates defines three second slots spaced apart from each other along the second direction. The three second slots in each of the second support plate penetrate toward a same direction. The second slots of two of the four second support plates located at opposite out sides along the third direction penetrate the fourth side, and the second slots of another two of the four second plates penetrate the third side.

In some embodiments, the first support plate and the second support plate are detachably connected together at least by a snap fit connection, the snap fit connection comprises a projection and a locking hole for correspondingly engaging with the projection; wherein, the first support plate is provided with the projection and/or the locking hole, the second support plate is correspondingly provided with the locking hole and/or the projection, and the projection is inserted into the locking hole, so that the first support plate and the second support plate are detachably connected together and intercrossed with each other.

In some embodiments, the support frame comprises multiple first support plates and multiple second support plates, the multiple first support plates and the multiple second support plates are vertically arranged in a first direction, the multiple first support plates are spaced from each other in a second direction, the multiple second support plates are spaced from each other in a third direction, the multiple first support plates and the multiple second support plates are intercrossed with each other and form a grid structure, and the first direction, the second direction and the third direction are perpendicular to each other.

In some embodiments, among the multiple first support plates, some of the multiple first support plates at opposite ends thereof are provided with projections at the third direction, and among the multiple second support plates, some of the multiple second support plates define locking holes at corresponding positions where the some of the second support plates are intercrossed with the some of the first support plates; and/or
among the multiple second support plates, some of the multiple second support plates at opposite ends thereof are provided with projections at the second direction, among the multiple first support plates, some of the multiple first support plates define locking holes at corresponding positions where the some of the multiple first support plates are intercrossed with the some of the multiple second support plates.

In some embodiments, among the multiple second support plates arranged along the third direction, two of the multiple second support plates located at head and tail positions are provided with the projections at their opposite ends on the second direction, among the multiple first support plates arranged along the third direction, two of first support plates located at head and tail positions are provided with the locking holes adjacent to their opposite ends on the third direction, and the projections of the two of the multiple second support plates located at head and tail positions, are inserted into the locking holes of the two of the multiple first support plates located at head and tail positions; rest of the multiple first support plates located at other positions are provided with the projections at their opposite ends on the third direction, two of the multiple second support plates located at head and tail positions are provided with the locking holes corresponding to the projections provided on the rest of the multiple first support plates located at other positions, the projections provided on the rest of the multiple first support plates at other positions are inserted into the locking holes provided in the two of the multiple second support plates located at head and tail positions.

In some embodiments, the first support plates each are provided with first slots at same position, among the multiple second support plates arranged along the third direction, the second support plates located at other positions are provided with second slots, the first slots and the second slots correspond to each other and have opposite orienting directions, enabling that the second support plates located at other positions can be intercrossed and detachably connected with the multiple first support plates.

In some embodiments, multiple support frames and multiple platforms are provided, the multiple support frames are juxtaposed, and each of the multiple support frames supports a corresponding one of the multiple platforms; or multiple support frames are provided, and the multiple support frames are juxtaposed, a platform is provided, and the multiple support frames cooperatively support the platform; or a support frame is provided, and multiple platforms are provided, and the multiple platforms are juxtaposed onto the support frame and supported by the support frame.

A second objective of the application provides a planting device, comprising an enclosing fence and the support assembly, the enclosing fence having an accommodating space; the platform and the support frame are arranged in the accommodating space, a planting zone is defined between the platform and the enclosing fence, for accommodating planting medium.

In some embodiments, the enclosing fence comprises: an enclosure, comprising a first side wall, a second side wall opposite to the first side wall, a third side wall and a fourth side wall opposite to the third side wall, opposite edges of the first side wall connected respectively with an edge of the third side wall and an edge of the fourth side wall, and opposite edges of the second side wall connected respectively with another edge of the third side wall and another edge of the fourth side wall, to enclosing the accommodating space which has opposite ends thereof opened; and a support rod, connecting the first side wall and the second side wall, to reinforce the enclosure.

In some embodiments, the first side wall and the second side wall each have a square inner wall or an arc-shaped inner wall; and/or the third side wall and the fourth side wall each have a square inner all or an arc-shaped inner wall; and/or the platform is a plate-shaped structure placed on a top of the support frame; and/or material of the first support plate and the second support plate is one of PP, PVC, ABS, PBT and PE.

It can be seen from the above technical solution that the support assembly proposed in this application comprising a platform and a supporting frame has simple structure. Every component of the support assembly can be set independently, and the support frame is formed by detachable connection of the first support plate and the second support plate, which is easy to assemble, convenient to disassemble, and has small volume after disassembly to facilitate transportation.

### BRIEF DESCRIPTION OF THE DRAWINGS

To more clearly expound the technical solution of embodiments of the application, a brief description will be provided below for the drawings that are necessary for illustrating the embodiments. Obviously, the drawings described below are provided for some of the embodiments of the application, and based on such drawings, those having ordinary skill in the art may envisage other drawings without creative endeavor.

FIG. 1 is a schematic perspective view showing a planting device provided in an embodiment of the application according to a first view;

FIG. 2 is a schematic perspective view showing the planting device provided in the embodiment of the application according to a second view;

FIG. 3 is a schematic exploded view showing the planting device provided in the embodiment of the application;

FIG. 4 is a schematic perspective view showing a support frame provided in the embodiment of the application;

FIG. 5 is a schematic exploded view showing the support frame provided in the embodiment of the application;

FIG. 6 is a schematic assembled view showing a first support plate and a second support of the support frame provided in the embodiment of the application;

FIG. 7 is a schematic perspective view showing an enclosing fence provided in an embodiment of the application;

FIG. 8 is a schematic exploded view showing the enclosing fence provided in an embodiment of the application.

FIG. 9 is a schematic perspective view showing a deformed structure of the support frame provided in the embodiments of the application.

FIG. 10 is a schematic exploded view shown the deformed structure of the support frame provided in the embodiments of the application.

### REFERENCE SIGNS OF THE DRAWINGS

100: plating device; 10: enclosing fence; 10a: accommodating space; 11: enclosure; 111: first side wall; 112: second side wall; 113: third side wall; 114: fourth side wall; 12: support rod; 20: platform; 20a: first platform; 20b: second platform; 20c: third platform; 30: support frame; 30a: first support frame; 30b: second support frame; 30c: third support frame; 31: first support plate; 31a: first side; 31b: second side; 311: first slot; 312: first limiting part; 32: second limiting part; 32a: third side; 32b: fourth side; 321: second slot; 322: second limiting part; 33: snap fit connection; 331: projection; 332: locking hole; 40 planting zone.

### DETAILED DESCRIPTION OF EMBODIMENTS

A clear and complete description of the technical solution provided in embodiments of the application is provided below with reference to the drawings of the embodiments of the application. Of course, the described embodiments are just some of the embodiments of the application, and are not all the embodiments thereof. Based on the embodiments of the application, those having ordinary skill in the art may, without paying creative endeavor, contemplate all the remaining embodiments, which all belong to the scope of protection of the application.

It should be understood that all directional instructions such as up, down, left, right, front, back . . . in the embodiments of the application are used only to explain/show more clearly the relative position relationship or motion situation between parts in a particular status. If the particular status changes, the directional indications change accordingly.

It should also be understood that when a component is said to be “fixed” or “set” to another component, it can be fixed/set to the another component directly by itself or through intermediate components between them. When a component is said to be “connected” to another component, it can be connected directly or indirectly through intermediate components to the another component.

It should also be understood that when a component is said to be “fixed” or “set” to another component, it can be fixed/set to the another component directly by itself or through intermediate components between them. When a component is said to be “connected” to another component, it can be connected directly or indirectly through intermediate components to the another component.

The terms used in this instruction of the application are not intended to restrict this application, but facilitate description of particular embodiments. For example, the description of “first”, “second” etc. in the application is for descriptive purposes only, it cannot be understood to indicate or imply the relative importance, or to implicitly hint the quantity of the indicated technical features. So, the features with definition of “first” or “second” may explicitly or implicitly include at least one such feature.

It should be further understood that the terms “and/or” used between related features listed in the description of application and the accompanying claims, refer to one of the related features or any combination of the related features or any possible combination of the related features, which can be comprised.

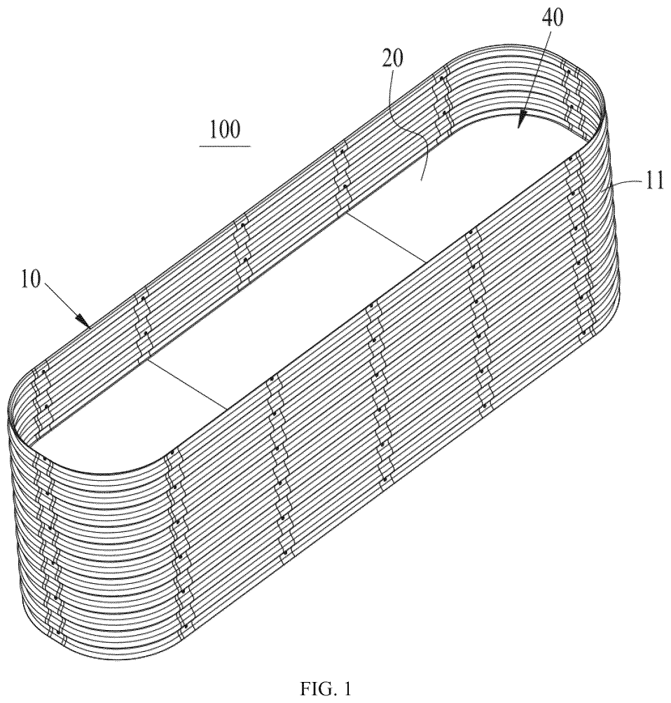

Referring to FIG. 1 to FIG. 3, a support assembly according to some embodiments of the application is applicable to a planting device 100. The support assembly comprises a platform 20 and a support frame 30. The platform 20 is configured to support planting medium thereon. The support frame 30 is arranged below the platform 20 for supporting the platform 20. The support frame 30 comprises first support plates 31 and second support plates 32 which are detachably connected and intercrossed with each other, for firmly supporting of the platform 20.

The support assembly according to some embodiments of the application, comprises the platform 20 and the support frame 30. The support assembly has a simple structure, and its every component can be formed separately and independently. The support frame 30 is assembled by detachable connection of the first support plates 31 and the second support plates 32. Thus, the support frame 30 is easy to be assembled together and convenient to be disassembled, and the disassembled support frame 30 occupies less volume and is convenient for transportation.

Some embodiments of the application provide a planting device 100 which comprises an enclosure 10 and the above-described support assembly. The enclosure 10 comprises an accommodating space 10a. The support frame 30 and the platform 20 are disposed in the accommodating space 10a. A planting zone 40 is formed between the platform 20 and the enclosure 10, for accommodating plant medium. The support assembly of the planting device 10 in this embodiment of the application has the same structure and function as the above-described support assembly which can be referred to, and not be repeated here.

As examples, the planting medium can be soil or other planting medium which can be used to plant vegetables, flowers, herbs and other plants.

Specifically, in some embodiments, the first support plate 31 and the second support plate 32 can be formed by processing metal sheets, and can be cut into any shape without new mold. The waste material removed from the metal sheets can also be recycled to reduce cost.

In some embodiments, the first support plate 31 and the second support plate 32 are both made of polypropylene (PP) material. Therefore, the first support plate 31 and the second support plate 32 made of PP plastic material are not only more environment-friendly and light in weight, but also does not need surface anti-corrosion treatment and new mold, therefore the cost is reduced. In other embodiments, the first support plate 31 and the second support plate 32 may also be formed by polyvinyl chloride (PVC), acrylonitrile-butadiene-styrene copolymer (ABS), polybutylene terephthalate (PBT), polyethylene (PE) or any other possible materials.

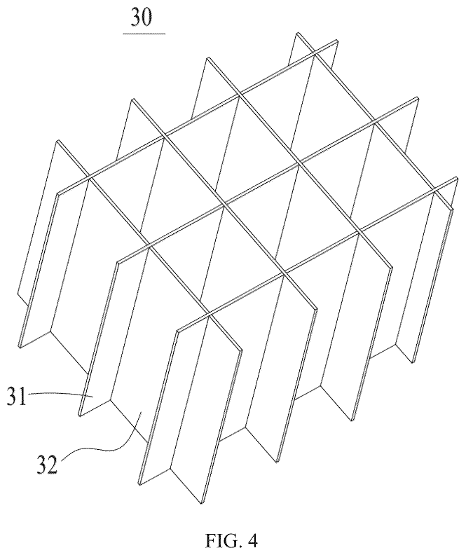

In some embodiments, as shown in FIG. 4 to FIG. 6, the first support plate 31 defines at least one first slot 311, and the second support plate 32 defines at least one second slot 321. Each first slot 311 corresponds to one of the second slots 321 in position so that the first support plate 31 and the second support plate 32 can be intercrossed to achieve a detachable connection therebetween. Therefore, the first support plate 31 and the second support plate 32 can be detachably connected together through the first slot 311 and the second slot 321. The assembly of the support frame 30 can be easily realized without using of additional fasteners such as screws etc. Thus, it is convenient for operation. Assembly/disassembly efficiency is improved, and product weight and cost are reduced.

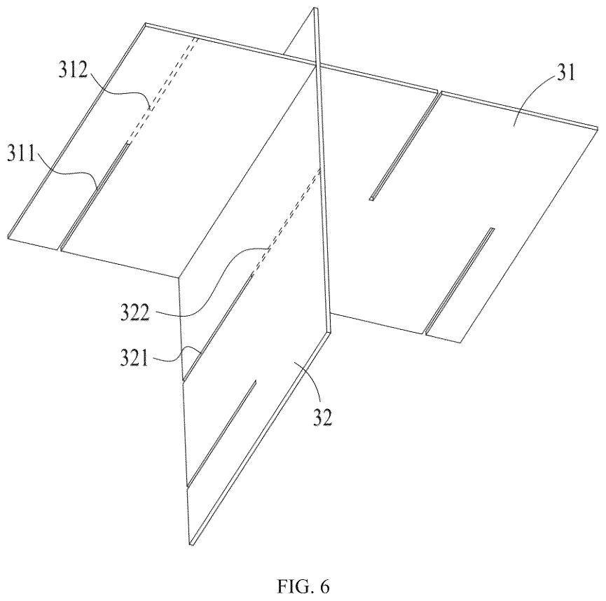

In some embodiments, as shown in FIG. 4 to FIG. 6, the first support plate 31 defines the first slots 311 which extends in a first direction. One end of the first slot 311 extends through one side of the first support plate 31 in the first direction. A first limiting part 312 is formed between another end of the first slot 311 and another side of the first support plate 31 in the first direction. As shown in FIG. 6, the dashed lines at the first support plate 31 are virtual lines for indicating the region where the first limit part 312 is located and are not physical present in the first support plate 31. The second support plate 32 defines a second slot 321 extending in the first direction. One end of the second slot 321 extends through one side of the second support plate 32 in the first direction. A second limiting part 322 is formed between another end of the second slot 321 and another side of the second support plate 32 in the first direction. As shown in FIG. 6, the dashed line at the second support plate 32 are virtual lines for indicating the region where the second limit part 322 is located and are not physical present in the second support plate 32. Arrangement of the first and second slots 311/321 allows the first limiting part 312 to be inserted into the second slot 321 and the second limiting part 321 to be inserted into the first slot 311, so that the first support plate 31 and the second support plate 32 are intercrossed, to achieve a detachable connection therebetween. Therefore, the first support plate 31 and the second support plate 32 can be intercrossed to form the support frame 30 which is stable enough to support the platform 20. It is convenient for operation. Assembly/disassembly efficiency is improved, and product weight and cost are reduced.

As shown in FIG. 4 to FIG. 6, in some embodiments, the first support plate 31 has a first side 31a and a second side 31b opposing to each other in the first direction. The first support plate 31 defines multiple first slots 311 arranged at interval, and one end of at least one first slot 311 penetrates the first side 31a, and one end of at least another one first slot 311 penetrates the second side 31b.

As shown in FIG. 4 to FIG. 6, in some embodiments, the second support plate 32 has a third side 32 and a fourth side 32b opposing to each other in the first direction. The second support plate 32 defines multiple second slots 321 arranged at interval. The second slots 321 penetrates the second support plate 32 toward the same direction, that is, all of the second slots 321 penetrates either the third side 32a or the fourth side 32b of the second support plate 32.

In some embodiments, the support frame 30 comprises multiple first support plates 31 and multiple second support plates 32. The amount of the first slots 311 in each of the multiple first support plate 31 is equal to the amount of the multiple second support plates 32, and the amount of the second slots 321 in each of the multiple second support plates is equal to the amount of the first support plates 31. The multiple first support plates 31 are arranged at interval along a second direction, and the multiple second support plates 32 are arranged at interval along a third direction. The multiple first support plates 31 and the multiple second support plates 32 are intercrossed with each other to form a grid structure. The first direction, the second direction and the third direction are perpendicular to each other. Illustratively, the first direction is the height direction of the planting device 100, the second direction and the third direction are two horizontal directions perpendicular to each other.

Accordingly, the multiple first support plates 31 and the multiple second support plates 32 can be intercrossed with each other to form a grid structure through the first slots 311 and the second slots 321, thereby improving stability of the support frame 30.

In some embodiments, the multiple first slots 311 are evenly arranged at interval, the multiple second slots 321 are evenly arranged at interval. The distance between adjacent two first slots 311 is equal to the distance between adjacent two second slots 321, so that the grid structure cooperatively formed by the multiple first support plates 31 and the multiple second support plates 32 which are intercrossed with each other, forms multiple squares when viewed from a top view vantage point, so as to improve the stability and facilitate to support the platform 20.

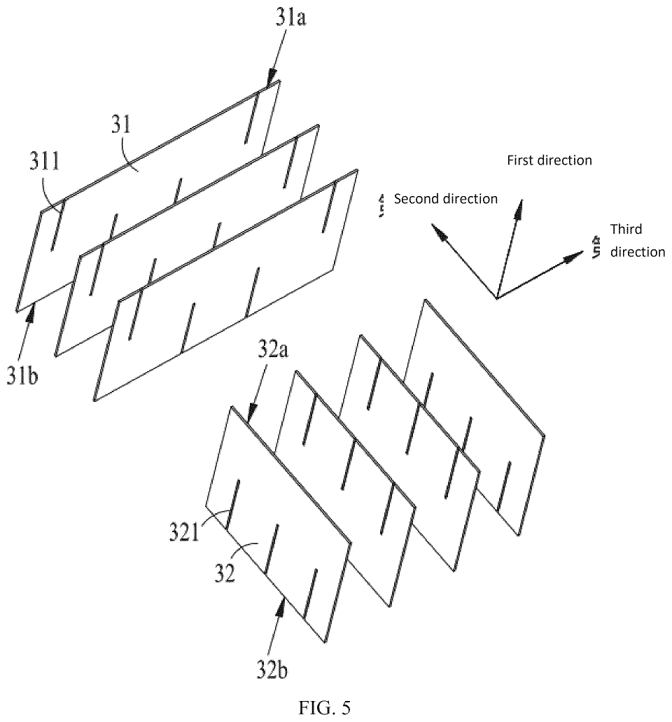

In some embodiments, the first side 31a and the third side 32a are oriented toward an upper side of the support frame 30, and the second side 31b and the fourth side 32b are oriented toward a lower side of the support frame 30. That is, among the multiple first slots 311 arranged at interval, at least one of the multiple first slots 311 penetrates the upper side of the corresponding first support plates 31, and at least one of the multiple first slots 311 penetrates the lower side of the corresponding first support plates 30. Specifically, two of the multiple first slots 311 adjacent to each other can penetrate sides of the first support plate 31 in different directions, i.e., one extending upwardly to penetrate the upper side of the first support plate 31 while the other one extending downwardly to penetrate the lower side of the first support plate 31; or alternatively, as shown in FIG. 5, the multiple first slots 311 located at two ends of the first support plates 31 extend upwardly to penetrate the upper side of the first support plate 31 while the rest of the multiple first slots 311 located at the middle of the first support plates 31 extend downwardly to penetrate the lower side of the first support plate 31. Understandably, the multiple first slots 311 may have any other feasibly arrangement. Obviously, the multiple first slots 311 orienting to different directions can make the connection between the first support plates 31 and the second support plates 32 more stable, to prevent the support frame 30 from falling apart.

In a specific application, the multiple second slots 321 of the second support plates 32 are oriented toward the same direction, so that each of the multiple second support plates 32 can be engaged simultaneously with the multiple first support plates 31. As shown in FIG. 5, each of the multiple second support plate 32 can be engaged simultaneously with three first support plates 31, and orienting direction of the multiple second slots 321 are opposite to the orienting direction of corresponding first slots 311, therefore the multiple first support plates 31 can be intercrossed and connected with the multiple second support plates 32. Since the first slots 311 of the multiple first support plates 31 are oriented toward different directions, the orienting directions of the second slots 321 of the multiple second support plates 32 are accordingly oriented toward different directions to make the connection between the multiple first support plates 31 and the multiple second support plates 32 more stable and prevent them from falling apart.

In one embodiment as shown in FIG. 5, the support frame 30 comprises three first support plates 31 and four second support plates 32. Each first support plate 31 defines four first slots 311 arranged at interval along the third direction. Among the four first slots 311 of each first support plate 31 along the third direction, two of the first slots 311 located at opposite sides penetrate the first side 31a, and another two of the first slots 311 located at the middle penetrate the second side 31b. Each second support plate 32 defines three second slots 321 arranged at interval along the second direction. Along the second direction, the three second slots 321 of each second support plate 32 penetrate the same end of the second support plate 32 toward the same direction. The second slots 321 of two of the second support plates 32 located at opposite outer sides in the third direction penetrate the fourth side 32b, and the second slots 321 of another two of the second plates 32 penetrate the third side 32a. Therefore, the three first support plates 31 and the four second support plates 32 can be intercrossed and connected together to form a stable grid structure to thereby improve the stability of the device.

Certainly, in other embodiments, the amounts of the first support plates and the second support plates 32 and arrangement of the first slots 311 and the second slots 321 are not restricted/limited as above-described. Other amounts of the first support plates 31 and the second support plates 32 with other types of arrangement of the first slots 311 and the second slots 321 can be used as long as the first support plates 31 and the second support plates 32 can be detachably and stably connected together to firmly support the platform 20.

In some embodiments, the first support plates 31 and the second support plates 32 have thickness of 4 mm-10 mm, for example, 4 mm, 5 mm, 7 mm, or 10 mm. Accordingly, the first slots 311 and the second slots 321 have widths matching with the thickness of the first support plates 31 and the second support plates 32.

In a specific application, the support frame 30, the platform 20 and the enclosing fence 10 can be formed independently. In use, the enclosing fence 10 is placed at a desired position for planting, then the support frame 30 is put into the accommodating space 10a, and the platform 20 is put on the top of the support frame 30, the top surface of the platform 20 and inner wall of the enclosing fence 10 cooperatively define the plant area 40. Thus, the planting device 100 is assembled together. Soil and other planting medium can be conveniently filled into the plant area 40 for planting. Since the plant area 40 is surrounded by the enclosing fence 10, no screw is needed and the planting device 100 has a stable structure which can be conveniently assembled or disassembled with a high efficiency and reduced cost.

In some embodiments, the support frame 30 and the platform 20 can be connected together by snap fit connections. Specifically, the first support plates 31 and/or the second support plates 32 are provided with protrusions at a top thereof, and the platform 20 is provided with limiting holes according to the protrusions, and the protrusions are engaged in the limiting holes respectively. Snap fit connections between the support frame 30 and the platform 20 enhance the stability of the platform 20. The protrusions can be lumps or strips.

It should be noted that the support frame 30 is not limited to be detachably engaged together by the way as above-described, for example, in some other embodiments, the first support plates and the second support plates can also be detachably engaged together by snap fit connections. Certainly, both engagement of the first slots and the second slots and snap fit connections can be applied between the multiple first support plates and the multiple second support plates, so that the multiple first support plates and the multiple second support plates can be intercrossed to form the grid structure.

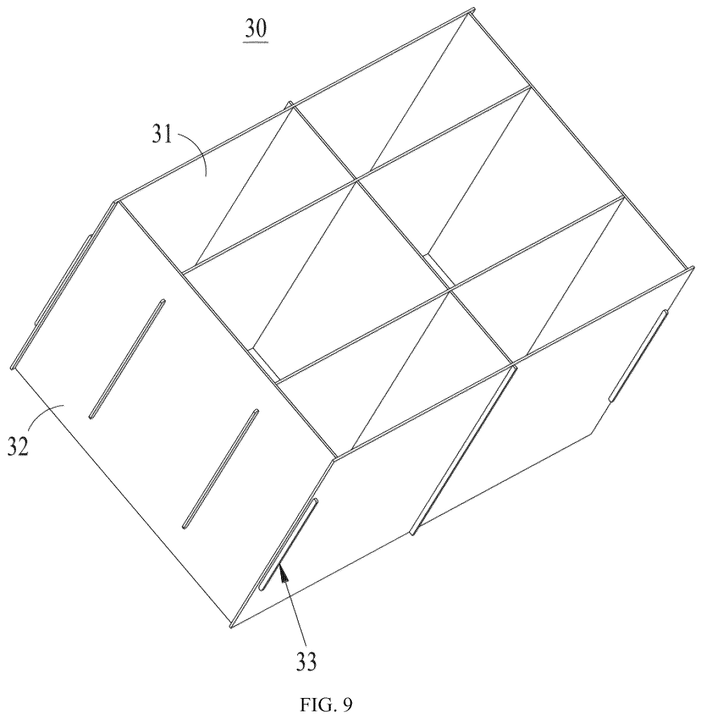

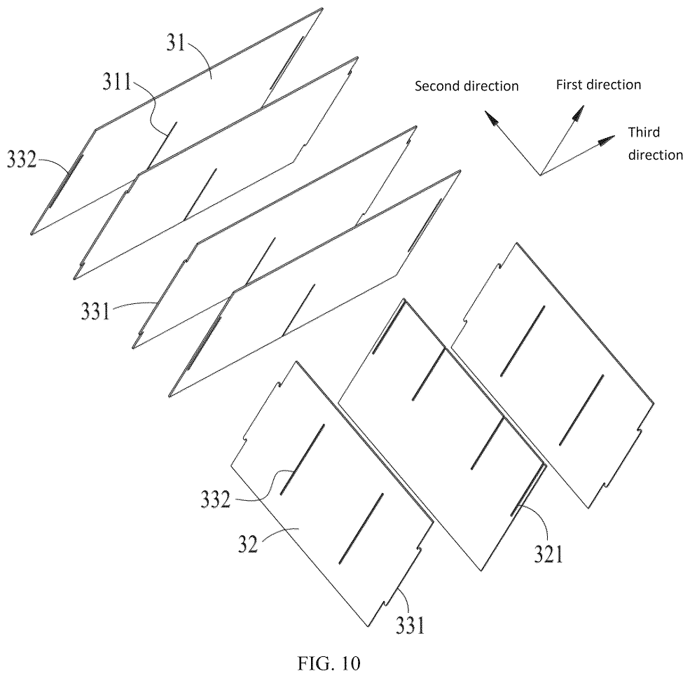

In some embodiments, as shown in FIG. 9 and FIG. 10, the first support plates 31 and the second support plates 32 are detachably connected together at least by means of snap fit connections 33. The snap fit connections 33 comprise projections 331 and locking holes 332 for correspondingly engaging with the projections 331. Wherein, the first support plates 31 are provide with the projections 331 and/or the locking holes 332, the second support plates 32 are correspondingly provided with the locking holes 332 and/or the projections 331. The projections 331 are engaged in the locking holes 332, so that the first support plates 31 and the second support plates 32 are detachably connected together and intercrossed with each other. Therefore, the first support plates 31 and the second support plate 32 can be detachably connected by the snap fit connections 33.

In some embodiments, the support frame 30 comprises multiple first support plates 31 and multiple second support plates 32. The multiple first support plates 31 and the multiple second support plates 32 are vertically arranged in the first direction, the multiple first support plates 31 are spaced from each other in the second direction, and the multiple second support plates 32 are spaced from each other in the third direction, and the multiple first support plates 31 and the multiple second support plates 32 are intercrossed with each other to form a grid structure. The first direction, the second direction and the third direction are perpendicular to one another. Therefore, the multiple first support plates 31 and the multiple second support plates 32 can be intercrossed together to form a stable grid structure by engaging of the projections 331 and the locking holes 332. As one example, parts of the multiple first support plates 31 form the projections 331 and corresponding parts of the second support plates 32 define the locking holes 332. Certainly, as another embodiment, it is feasible that parts of the multiple first support plates 31 are provided with the locking holes 332 and the corresponding parts of the second support plates 32 form the projections 331. It can be that a same one of the multiple second support plates 32 is provided simultaneously with the locking holes 332 and the projections 331 respectively at its different positions, or the multiple second support plates 32 located at different positions are provided respectively with the locking holes 332 and the projections 331. Certainly, it is also feasible that parts of the multiple first support plates 31 are provided with the projections 331 and the locking holes 332, and the corresponding parts of the second support plates 32 are provided with the locking holes 332 and the projections 331 corresponding to the projections 331 and the locking holes 332 of the first support plates 31 respectively, so that the multiple first support plates 31 and the multiple second support plates 32 can be intercrossed to achieve a stable grid structure.

In some embodiments, among the multiple first support plates 31, some of the first support plates 31 are provided with the projections 331 at opposite ends thereof at the third direction. Among the multiple second support plates 32, some of the second support plates 32 define the locking holes 332 at corresponding positions where the some of the second support plates 32 are intercrossed with the some of the first support plates 31. Accordingly, the projections 331 of the first support plates 31 are engaged with the locking holes 332 of the second support plates 32, so as to realize detachably connection between the some of the first support plates 31 and the some of the second support plates 32.

In some embodiments, among the multiple second support plates 32, some of the second support plates 32 are provided with the projections 331 at opposite ends thereof at the second direction. Among the multiple first support plates 31, some of the first support plates 31 define the locking holes 332 at corresponding positions where the some of the first support plates 31 are intercrossed with the some of the second support plates 32. Accordingly, the locking holes 332 of the first support plates 31 are engaged with the projections 331 of the second support plates 32, so as to realize detachably connection between the some of the first support plates 31 and the some of the second support plates 32.

In some embodiments, some of the first support plates 31 are provided with the projections 331 and the corresponding second support plates 32 are provided with locking holes 332, and another some of the first support plates 31 are provided with the locking holes 332 and the corresponding second support plates 32 are provided with the projections 331, which makes the connection between the multiple first support plates 31 and the multiple second support plates more stable, preventing the support frame from falling apart.

As an embodiment, as shown in FIG. 10, among the multiple second support plates 32 arranged along the third direction, the two second support plates 32 located at head and tail positions are provided with the projections 331 at their opposite ends on the second direction. Among the multiple first support plates 31 arranged along the third direction, the two first support plates 31 located at head and tail positions are provided with the locking holes 332 adjacent to their opposite ends on the third direction so that the projections 331 of the two second support plates 32 located at head and tail positions are inserted and engaged in the locking holes 332 of the two of the multiple first support plates 31 located at head and tail positions. Rest of the multiple first support plates 31 located at other positions are provided with the projections 331 at opposite ends thereof on the third direction, the two of the multiple second support plates 32 located at head and tail positions are provided with the locking holes 332 corresponding to the projections 331 provided on the rest of the multiple first support plates 31 located at other positions, so that the projections 331 provided on the rest of the multiple first support plates 31 at other positions can be inserted and engaged in the locking holes 332 provided in the two of the multiple second support plates 32 located at head and tail positions. Therefore, the two second support plates 32 located at head and tail positions can be connected with the multiple first support plates 31 by engagement of the projections 331 and the locking holes 332. Certainly, it is feasible that positions of the projections 331 of the first support plates 31 and the locking holes 332 of the second support plate 32 can be exchanged. Understandably, other feasible ways can also be adopted so that the multiple first support plates 31 and the multiple second support plates 32 can be intercrossed and connected together to form a stable grid structure.

In some embodiments, as shown in FIG. 10, all of the first support plates 31 are provided with first slots 311 at same position. Among the multiple second support plates 32 arranged along the third direction, the second support plates 32 located at other positions are provided with second slots 321. The first slots 311 and the second slots 321 correspond to each other on positions and opposite to each other on orienting directions, which allows the second support plates 32 located at other positions can be intercrossed and detachably connected with the multiple first support plates 31. Therefore, engagement of the first slots 311 and the second slots 321 enables the second support plates 32 in middle region of the support frame 30 to be connected with each of the first support plates 31, to realize more stable connection between the multiple first support plates 31 and the multiple second support plates 32 not only by engagement of the first slots 311 and the second slots 321 but also by the snap fit connection 33.

In some embodiments, as shown in FIG. 9 and FIG. 10, the amount of the first support plates 31 may be four, and the amount of the second support plates 32 may be three. The first support plates 31 each in middle region thereof are provided with a first slot 311 with orienting direction downward; the second support plate 32 in middle is provided with four second slots 321 with orienting direction upward, corresponding to the four first support plates 31; the two first support plates 31 located at head and tail are provided with locking holes 332 adjacent opposite ends thereof, and the two second support plates 32 located at head and tail are provided with projections 331 at opposite ends thereof; the two first support plates 31 in middle region of the support frame 30 are provided with projections 331 at opposite ends thereof, and the two second support plates 32 located at head and tail are correspondingly provided with locking holes 332; so that the four first support plates 31 and the three second support plate 32 can be detachably connected by engagement of the projections 331 and the locking holes 311 and engagement of the first slots 311 and the second slots 321. It can be understood that in other examples, orienting directions of the first slots 311 and the second slots 321 can be exchanged.

Certainly, in other embodiments, the amount of first support plates 31, the amount of the second support plates 32 and the arrangement of the projections 331 and the locking holes 332 are not limited as above-described, any other feasible ways can be adopted so long as the first support plates 31 and the second support plates 32 can ben detachably and stably connected to firmly support the platform 20.

In some embodiments, as shown in FIG. 1 to FIG. 3, multiple support frames 30 and multiple platforms 20 are provided, and their amount is not limited. The multiple support frames 30 are juxtaposed in the accommodating space 10a, and each support frame 30 supports one platform 20. For example, the multiple support frames 30 and the multiple platform 20 can be arranged along a length direction of the enclosing fence 10. Therefore, the multiple support frames 30 can support the multiple platforms 20 to thereby increase the plant area 40. Multiple sets of support frames 30 and platforms 20 are simultaneously arranged in one enclosing fence 10 allows the planting device 100 to be a modular structure which can decrease volume of the planting device 100 after being disassembled, save space occupied by the plating device 100, and to thereby facilitate transportation and reduce transportation cost.

In a specific application, the multiple support frames 30 can be independent from each other, and the multiple platforms 20 can also be independent from each other. In use, the multiple support frames 30 can be directly juxtaposed into the accommodating space 10a of the enclosing fence 10, then the multiple platforms 20 are juxtaposed onto the multiple support frames 30, to obtain a stable structure without using of screws etc.

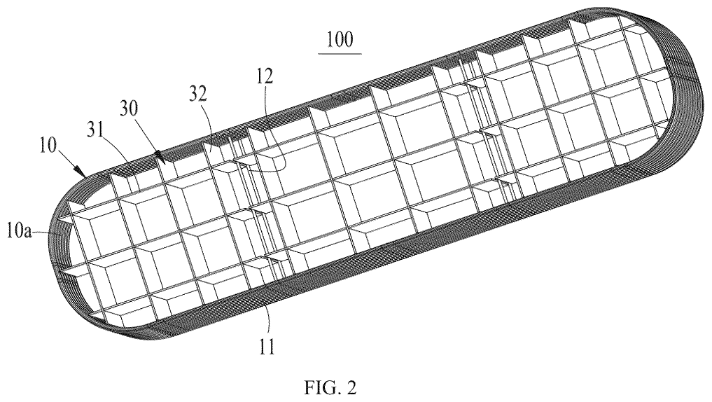

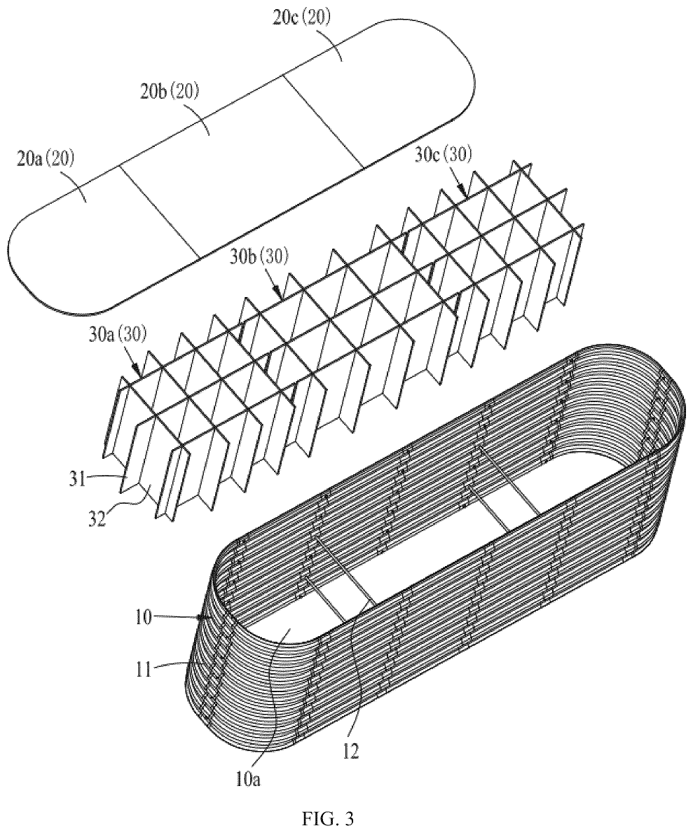

As an embodiment, as shown in FIG. 3, the amount of the support frames 30 is the same as that of the platforms 20. Referring to FIG. 2, the planting device 100 comprises three support frames 30 which are respectively a first support frame 30a, a second support frame 30b and a third support frame 30c, and further comprises three platforms 20 which are respectively a first platform 20a, a second platform 20b and a third platform 20c, wherein the first support frame 30a supports the first platform 20a, the second support frame 30a supports the second platform 20a, and the third support frame 30a supports the third platform 20a.

As an alternative embodiment, the amount of the support frames 30 is not the same as that of the platforms 20, for example, the planting device 100 comprises three support frames 30 and two platforms 20, and adjacent two of the support frames 30 cooperatively support one of the platforms 20.

In some other embodiments, multiple support frames 30 and one platform 20 are provided. The multiple support frames 30 are juxtaposed in the accommodating space 10a and cooperatively support the platform 20. Wherein, the platform 20 has an area approximately equal to the total of the top area of the multiple supporting structures 30, that is, the platform 20 is integrally made, and doesn't need to be divided into multiple independent supporting structures.

In some other embodiments, one support frame 30 and multiple platforms 20 are provided. The multiple platforms 20 are juxtaposed onto the support frame 30, that is, only one support frame 30 is needed to support the multiple platforms 20. For example, the first support plates 31 can be extended to obtain an integral support frame 30 which is large enough to support the multiple platforms 20. That is, only one independent support frame 30 is needed, and don't need to be divided into multiple independent support frames.

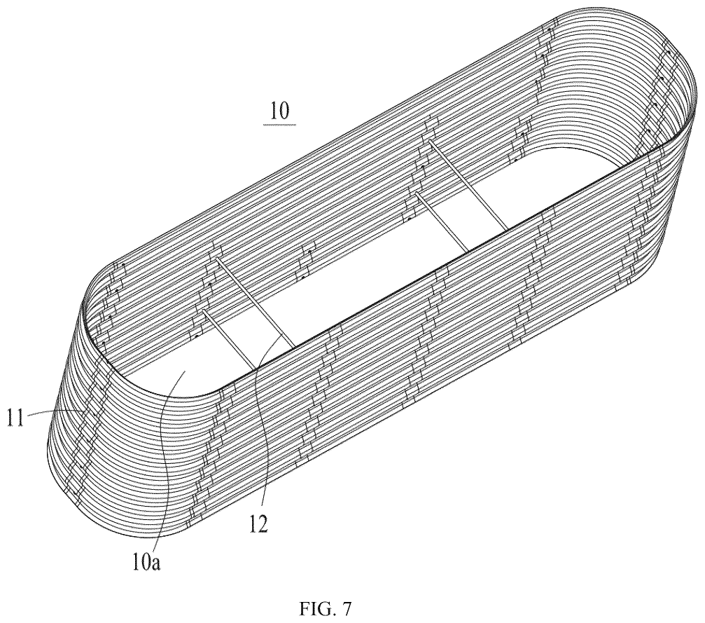

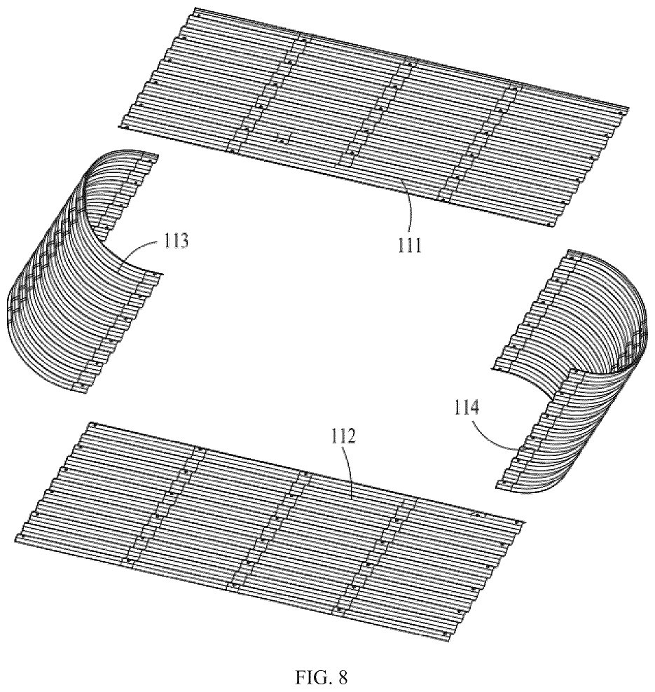

In some embodiments, as shown in FIG. 1-FIG. 3, FIG. 7 and FIG. 8, the enclosing fence 10 comprises an enclosure 11 and support rods 12. The enclosure 11 comprises a first side wall 111 and a second side wall 112 opposite to each other, a third side wall 113 and a fourth side wall 114 opposite to each other. Opposite edges of the first side wall 111 are connected respectively with an edge of the third side wall 113 and an edge of the fourth side wall 114, and opposite edges of the second side wall 112 are connected respectively with another edge of the third side wall 113 and another edge of the fourth side wall 114, to thereby define an accommodating space 10a which has opposite open ends. The support rods 12 are arranged between the first side wall 111 and the second side wall 112 to connect the first side wall 111 and the second side wall 112, in order to reinforce the enclosure 11. Therefore, one open end of the enclosure 11 faces downward to the ground and another open end faces upward to provide an access to allow the support frames 30 and the platforms 20 to enter into the accommodating space 10a and form the planting zone 40. The support rods 12 are provided to hold the first side wall 111 and the second side wall 112 together, preventing the enclosure 11 from deformation and improving stability.

In a specific application, when multiple support frames 30 are provided, the support rods 12 may be arranged between adjacent support frames 30, to avoid interference with the support frames 30. As an example, referring to FIG. 2, when three support frames 30 are provided, two sets of the support rods 12 are correspondingly provided, each set of the support rods 12 comprises two support rods 12 which are arranged between adjacent two of the support frames 30, to stabilize the enclosure and simultaneously avoid the support frames 30.

In some embodiments, as shown in FIG. 7 and FIG. 8, the first side wall 111 and the second side wall 112 each have a square configuration, the third side wall 113 and the fourth side wall 114 each have an arc-shaped configuration. Opposite ends of the platform 20 have arc-shaped configurations matched with the arc-shaped configurations of the third side wall 113 and the fourth side wall 114. Certainly, in other embodiments, the first side wall 111 and the second side wall 112 can each have an arc-shaped configuration, and the third side wall 113 and the fourth side wall 114 can each have a square configuration.

As exampled, the enclosure 11 as a whole may be in oval structure as shown in FIG. 1 to FIG. 3, or may be in regular circular or square structure, even in any irregular structure, so long as it can encircle a certain area to form a garden bed.

In some embodiments, the enclosure 11 can be formed by multiple plates assembled together through screws and nuts or any other fixing ways. Wherein, the first side wall 111, the second side wall 112, the third side wall 113 and the fourth side wall 114 each may be formed by a single integral plate, or formed by multiple individual plates assembled together.

In some embodiment, as shown in FIG. 1 and FIG. 3, the platform 20 has a plate-shaped configuration and is placed on the top of the support frames 30. The platform 20 may be formed by a single integral plate, or may be formed by multiple individual plates juxtaposed together, and the multiple individual plates occupy less packing volume after being disassembled and save transportation cost. The multiple individual plates are tiled on the support frames 30, without using of screws or any other fixing structure, which facilitates disassembly and assembly.

In the case of without contradiction, a technician in the field may combine the different embodiments or examples, or the characteristics of the different embodiments or examples described in this specification.

The above provides only specific ways of implementation for the application; however, the scope of protection that the application pursues is not limited thereto. Those having ordinary skill in the field of the art may contemplate various equivalent modifications or substitutes within the technical scope of the disclosure, and such modifications and substitutes should be considered failing with the scope of protection of the application. Thus, the scope of protection of the application is determined only by the scope of the claims.

What is claimed is:

1. A support assembly, appliable to a planting device, comprising:
a platform configured for supporting planting medium; and
a support frame arranged below the platform and configured for supporting the platform;
wherein the support frame comprises a first support plate and a second support plate which are detachably connected together and intercrossed with each other, for firmly support of the platform.

2. The support assembly according to claim 1, wherein the first support plate defines at least one first slot, and the second support plate defines at least one second slot, the at least one first slot corresponds to the at least one second slot in position so that the first support plate and the second support plate are able to be intercrossed to achieve a detachable connection therebetween.

3. The support assembly according to claim 1, wherein the first support plate defines a first slot extending in a first direction, an end of the first slot penetrating a side of the first support plate in the first direction, and a first limiting part is formed between an opposite end of the first slot and an opposite side of the first support plate in the first direction; and
the second support plate defines a second slot extending in the first direction, an end of the second slot penetrating a side of the second support plate in the first direction, and a second limiting part is formed between an opposite end of the second slot and another side of the second support plate in the first direction;
wherein the first limiting part is inserted into the second slot and the second limiting part is inserted into the first slot so that the first support plate and the second support plate are intercrossed to achieve a detachable connection therebetween.

4. The support assembly according to claim 3, wherein the first support plate has a first side and a second side opposing to the first side in the first direction, the first support plate defines multiple first slots apart from each other, and the end of at least one of the multiple first slots penetrates the first side of the first support plate, and the end of at least another one of the multiple first slots penetrates the second side.

5. The support assembly according to claim 4, wherein the second support plate has a third side and a fourth side opposing to the third side in the first direction, the second support plate defines multiple second slots apart from each other, and all of the multiple second slots penetrate the second support plate toward a same direction.

6. The support assembly according to claim 5, wherein the support frame comprises multiple first support plates and multiple second support plates, an amount of the first slots in each of the multiple first support plates is equal to an amount of the multiple second support plates, and an amount of the second slots in each of the multiple second support plates is equal to an amount of the multiple first support plates; and
the multiple first support plates are arranged at interval along a second direction, the multiple second support plates are arranged at interval along a third direction, the multiple first support plates and the multiple second support plates are intercrossed with each other to form a grid structure, and the first direction, the second direction and the third direction are perpendicular to one another.

7. The support assembly according to claim 6, wherein the support frame comprises three first support plates and four second support plates;
each of the three first support plates defines four first slots spaced apart from each other along the third direction; in each of the three first support plates, two of the four first slots located at opposite sides penetrate the first side, and another two of the four first slots located at middle penetrate the second side; and
each of the four second support plate defines three second slots spaced apart from each other in the second direction; the three second slots in each of the four second support plate penetrate toward a same direction; the second slots formed at two of the four second support plates located at head and tail positions in the third direction penetrate the fourth side, and the second slots formed at another two of the four second plates penetrate the third side.

8. The support assembly according to claim 1, wherein the first support plate and the second support plate are detachably connected together at least by a snap fit connection, the snap fit connection comprises a projection and a locking hole corresponding to the projection;
wherein the first support plate is provided with the projection and/or the locking hole, the second support plate is correspondingly provided with the locking hole and/or the projection, and the projection is engaged in the locking hole, so that the first support plate and the second support plate are detachably connected together and intercrossed with each other.

9. The support assembly according to claim 8, wherein the support frame comprises multiple first support plates and multiple second support plates, the multiple first support plates and the multiple second support plates are vertically arranged in a first direction, the multiple first support plates are spaced from each other in a second direction, the multiple second support plates are spaced from each other in a third direction, the multiple first support plates and the multiple second support plates are intercrossed with each other to form a grid structure, and the first direction, the second direction and the third direction are perpendicular to one another.

10. The support assembly according to claim 9, wherein some of the multiple first support plates are provided with projections at opposite ends thereof in the third direction, and some of the multiple second support plates define locking holes at corresponding positions where the some of the second support plates are intercrossed with the some of the first support plates; and/or
some of the multiple second support plates are provided with projections at opposite ends thereof at the second direction, and some of the multiple first support plates define locking holes at corresponding positions where the some of the multiple first support plates are intercrossed with the some of the multiple second support plates.

11. The support assembly according to claim 10, wherein among the multiple second support plates arranged in the third direction, two of the multiple second support plates located at head and tail positions are provided with the projections at opposite ends thereof in the second direction; among the multiple first support plates arranged along the second direction, two of the first support plates located at head and tail positions are provided with the locking holes adjacent to opposite ends thereof in the third direction, and the projections of the two of the multiple second support plates located at head and tail positions in the third direction are respectively engaged in the locking holes of the two of the multiple first support plates located at head and tail positions in the second direction; and
rest of the multiple first support plates located at other positions are provided with the projections at opposite ends thereof in the third direction, the two of the multiple second support plates located at head and tail positions are provided with the locking holes corresponding to the projections provided on the rest of the multiple first support plates located at other positions, the projections provided on the rest of the multiple first support plates at other positions are engaged in the locking holes formed in the two of the multiple second support plates located at head and tail positions.

12. The support assembly according to claim 11, wherein all of the first support plates are provided with first slots at same positions; among the multiple second support plates arranged along the third direction, the second support plates located at other positions are provided with second slots, the first slots and the second slots correspond to each other and have opposite orienting directions so that the second support plates located at other positions can be intercrossed and detachably connected with the multiple first support plates.

13. The support assembly according to claim 1, wherein multiple support frames and multiple platforms are provided, the multiple support frames are juxtaposed, and each of the multiple support frames supports a corresponding one of the multiple platforms; or
multiple support frames are provided, and the multiple support frames are juxtaposed, one platform is provided, and the multiple support frames cooperatively support the platform; or
one support frame is provided, and multiple platforms are provided, and the multiple platforms are juxtaposed onto the support frame and supported by the support frame.

14. A planting device, comprising:
an enclosing fence, having an accommodating space; and
a support assembly comprising a platform for bearing planting medium and a support frame arranged below the platform for supporting the platform;
wherein the support frame comprises a first support plate and a second support plate, the first support plate and the second support plate are detachably connected together and intercrossed with each other, for firmly support of the platform; and
wherein the platform and the support frame are arranged in the accommodating space with a planting zone being formed between the platform and the enclosing fence for accommodating planting medium.

15. The planting device according to claim 14, wherein the enclosing fence comprises:
an enclosure, comprising a first side wall, a second side wall opposite to the first side wall, a third side wall and a fourth side wall opposite to the third side wall, opposite edges of the first side wall connected respectively with an edge of the third side wall and an edge of the fourth side wall, and opposite edges of the second side wall connected respectively with another edge of the third side wall and another edge of the fourth side wall, to thereby surround the accommodating space which has opposite open ends and
a support rod, connecting the first side wall and the second side wall to reinforce the enclosure.

16. The planting device according to claim 15, wherein the first side wall and the second side wall each have a square configuration or an arc-shaped configuration.

17. The planting device according to claim 15, wherein the third side wall and the fourth side wall each have a square configuration or an arc-shaped configuration.

18. The planting device according to claim 15, wherein the platform is a plate-shaped structure placed on a top of the support frame.

19. The planting device according to claim 15, wherein material of the first support plate and the second support plate is one of PP, PVC, ABS, PBT and PE.
